(19) United States
(12) Patent Application Publication
(10) Pub. No.: US 2014/0069593 A1
(43) Pub. Date: Mar. 13, 2014

(54) Garage Door Assembly

(71) Applicant: Manon Gravel, Becancour (CA)

(72) Inventor: Manon Gravel, Becancour (CA)

(21) Appl. No.: 14/016,314

(22) Filed: Sep. 3, 2013

Related U.S. Application Data
(60) Provisional application No. 61/698,312, filed on Sep. 7, 2012.

(51) Int. Cl. E06B 9/52; E06B 3/48

(52) U.S. Cl. CPC E06B 9/52; E06B 3/485
USPC 160/89

(57) ABSTRACT

In a sectional overhead garage door assembly, the problem of opening the garage door for aeration or else, while preventing small animals to enter, is solved by i) making the last and the next to last panels of the door detachable so that the last panel may remain on the ground, ii) by providing the last panel with at least one first attachment, and iii) by mounting a screen to one of a) the frame of the door and b) the next to last panel, so as to be deployable in front of the opening when the last panel is detached and the other panels are raised. The deployable screen has at least one second attachment for cooperating with the at least one first attachment for removably attaching the deployable screen to the last panel.

### CROSS-REFERENCE TO RELATED APPLICATION

This application claims the benefit of U.S. Provisional Application No. 61/698,312, filed on Sep. 7, 2012, the content of which is incorporated by reference herein.

### FIELD

The present disclosure generally relates to garage doors. More specifically, the present disclosure is concerned with a garage door assembly including a mosquito net.

### BACKGROUND

Among the many types of garage doors, the sectional overhead doors are among the most popular for style, safety, security and ease of use. They include a series of panels abutted so that two adjacent panels are pivotably mounted to one another. Such a system can be moved between closed and opened configuration by sliding the panel assembly along lateral tracks between vertical and horizontal positions by way of a cable and pulley system that is motorized by a small electric motor or which is operated manually.

A drawback of conventional sectional overhead garage doors, which is shared by all garage door types, is that, by their nature and size, they do not easily accommodate a screen door.

The attempts to fix a screen door to a garage door opening may be so far split in two categories. In the first one, the conventional opaque door is replaced by a screen door. While this solution may be acceptable in a temperate climate, there is always the problem of perpetual vulnerability against theft.

Other attempts to integrate a screen for opening garage doors are temporary solutions. These generally includes deploying a window screen in front of the garage door opening while the door is open, and maintaining the screen in position by using either brackets that are removably mounted to the garage door, self standing poles, or others. The drawbacks of the temporary solutions are numerous, including: questionable strength of the resulting assembly, imprecise fit of the window screen in the garage door opening, doubtful aesthetic appearance, etc.

### SUMMARY

An object is generally to provide a garage door assembly that aims at solving the problem of opening a garage door for aeration or else, while preventing small animals to enter the opening closed by the garage door.

More specifically, in accordance with an illustrative embodiment, there is provided a garage door assembly for closing an opening that is at least partially circumscribed by a frame, the garage door assembly comprising:
a series of abutting panels assembled in such a way that two adjacent panels are interconnected to allow pivotal movement therebetween; the panels being slidably mounted in two lateral parallel tracks therebetween for reciprocal movement in unison therealong, between a lowered position, wherein the opening is closed, and a raised position, wherein the opening is clear; the series of abutting panels including a last and a next to last panels that are detachable; the last panel having at least one first attachment;
a screen mounted to one of i) the frame and ii) the next to last panel so as to be deployable in front of the opening when the last panel is detached and the other panels are in the raised position;
the screen having at least one second attachment for cooperating with the at least one first attachment for removably attaching the deployable screen to the last panel.

In accordance to another embodiment, there is provided a kit for retrofitting a sectional overhead garage door assembly with a selectively deployable screen; the garage door assembly including a series of abutting panels assembled in such a way that two adjacent panels are interconnected to allow pivotal movement therebetween; the panels being slidably mounted in two lateral parallel tracks therebetween for reciprocal movement in unison therealong, between a lowered position, wherein the opening is closed, and a raised position, wherein the opening is clear; the kit comprising:
separable hinges, each having a first part mountable to the last panel and a second part mountable to the next to last panel of the series of abutting panels and a removable pivot pin that holds together the first and second parts;
at least one first attachment for mounting to the last panel; and
a screen for mounting to the next to last panel or to a frame of the garage door assembly to be deployable in front of the opening when the last panel is detached from the next to last panel and the other panels are in the raised position; the screen having at least one second attachment for cooperating with the at least one first attachment for removably attaching the deployable screen to the last panel.

Other objects, advantages and features of the present disclosure will become more apparent upon reading the following non restrictive description of illustrated embodiments thereof, given by way of example only with reference to the accompanying drawings.

### BRIEF DESCRIPTION OF THE DRAWINGS

In the appended drawings:

FIG. 1 is a back elevation of a garage door assembly according to a first illustrative embodiment; the garage door assembly being shown closed, with the last two panels still attached and the mosquito screen partially deployed;

FIG. 2 is a front elevation of the garage door assembly from FIG. 1; the garage door assembly being shown opened, with the last two panels detached, and with the screen completely deployed;

FIG. 3 is a front perspective view of a garage door assembly according to a second illustrative embodiment; the garage door being shown opened with the mosquito screen deployed;

FIG. 4 is a back perspective of the garage door assembly from FIG. 3, illustrating the locking mechanism between the last two panels;

FIG. 5 is a side elevation of the garage door assembly from FIG. 3, illustrating the attachment of the deployed screen to the last panel when the last panel is detached;

FIG. 5A is a close up view taken along line 5A-5A in FIG. 5; and

FIG. 6 is a front perspective view of a garage door assembly according to a third illustrative embodiment; the garage door being shown opened with the mosquito screen deployed.

### DETAILED DESCRIPTION

In the following description, similar features in the drawings have been given similar reference numerals, and in order not to weigh down the figures, some elements are not referred to in some figures if they were already identified in a previous figure.

The use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements.

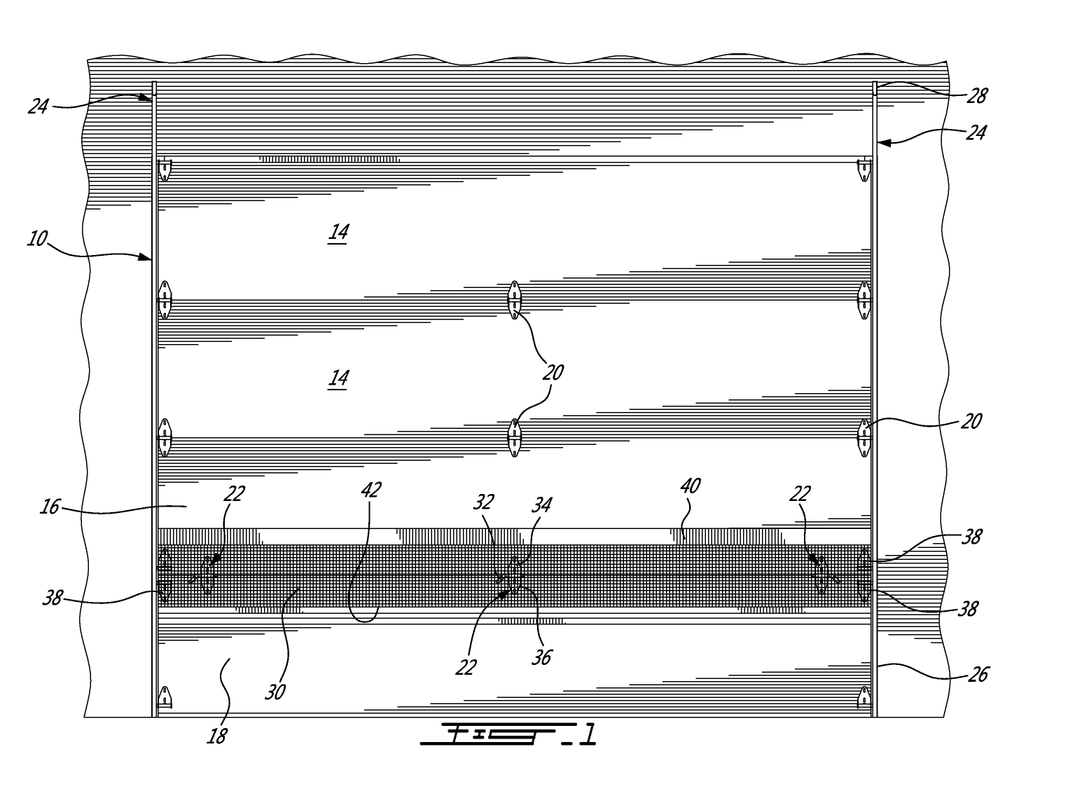

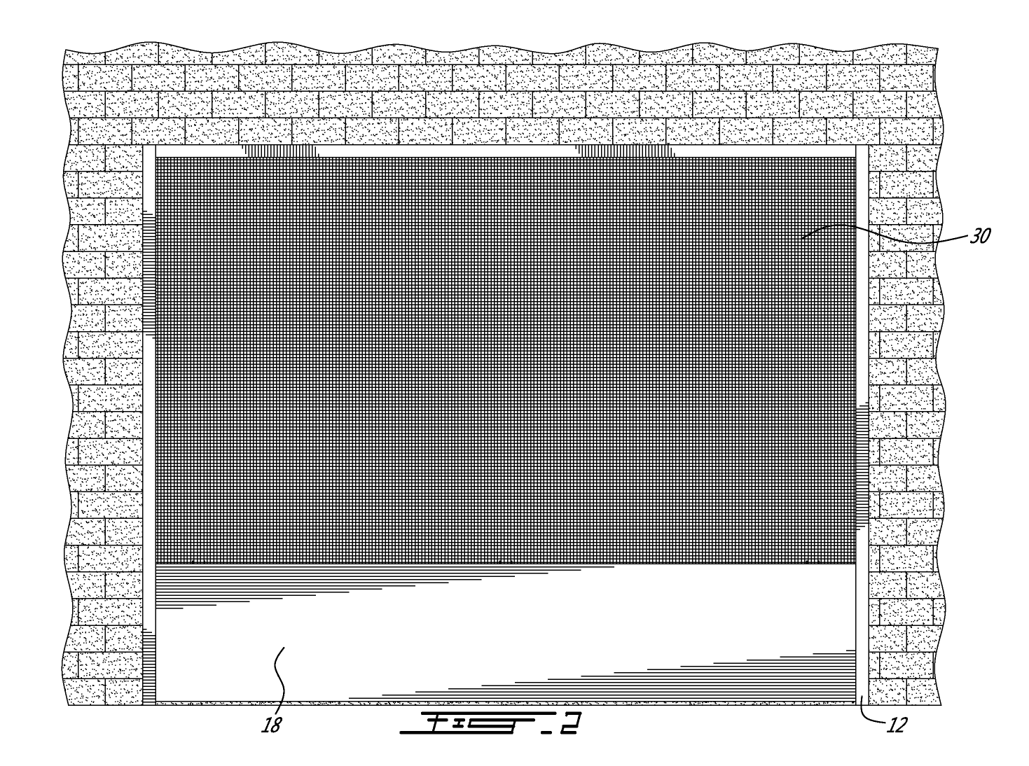

A garage door assembly 10 according to a first illustrative embodiment will be described with reference to FIGS. 1 and 2. The garage door assembly 10 closes a generally rectangular opening partially circumscribed by a frame 12.

Since garage door assemblies according to illustrative embodiments are similar to conventional sectional overhead garage door assemblies, only the differences therewith will be described herein for concision purposes.

The garage door assembly 10 comprises a series of identical abutting panels 14, 16 and 18 that are assembled in such a way that two adjacent panels 14-14, 14-16 and 16-18 are so interconnected to allow pivotal movement therebetween. More specifically, each two adjacent panels 14-18 are assembled using conventional hinges 20 between panels 14 and 16 and two-parts separable hinges 22.

According to the first illustrated, each pair of panels 14-14, 14-16 and 16-18 is pivotally assembled using three hinges 20 or 22: one at the center of the pair of panels, and the other two near the lateral edges thereof.

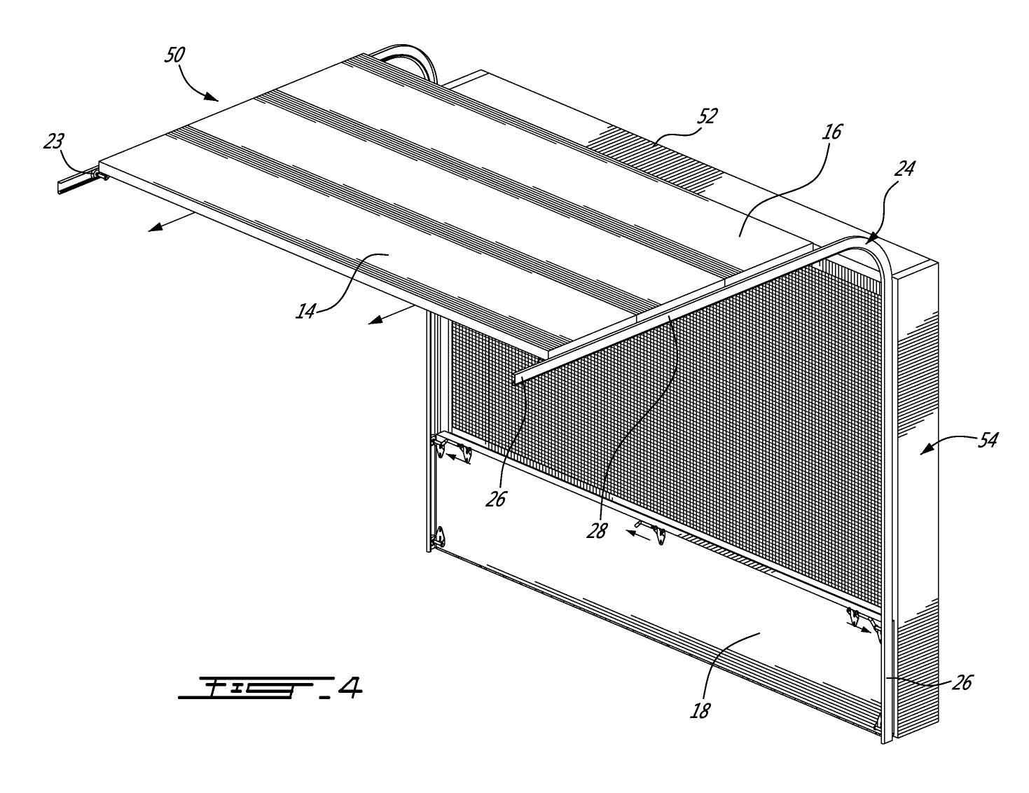

The two lateral hinges 20 are further provided with rollers 23 (see on FIG. 4) that slidably mount the four panels 14-18 in two lateral parallel tracks 24 therebetween for reciprocal movement in unison therealong between an upright lowered position, wherein the opening is closed, and a raised position, wherein the opening is clear.

The tracks 24 conventionally includes a lower vertical portion 26, a generally horizontal portion 28 and an arcuate transitional portion 29 therebetween.

Whenever there is sufficient space above the door frame 12 inside the building, it has been found advantageous to extend the tracks 24 vertically beyond the maximum height of the opening so that the panels 14-16 move away from the vertical only once they are completely inside the building. As this will be described hereinbelow in more detail, such an arrangement allows a deployable screen 30 mounted to the door panel 16 to cover all area of the door opening above the panel 18 when the screen 30 is deployed.

As mentioned hereinabove, the last panel 18 and next to last panel 16 are detachably assembled via three separable hinges 22. These hinges 22, that can be better seen in FIG. 4, include a removable pivot pin 32 that holds together top and bottom portions 34-36 of the hinge 22 in a quick connect manner. The distal panel 18, also referred to herein as the lowest or last panel, can therefore be selectively detached from the other panels 14-16 so as to stay on the ground when the door is opened.

The separable panels 16 and 18 include additional rollers (not shown) to prevent their tilting off the tracks 24 when they are separated. These additional rollers are mounted to the panels 16 and 18 via brackets 38.

An elongated container 40 is secured to the next to last panel 16 which includes a deployable screen in the form of a mosquito net 30. More specifically, the net 30 is wrapped on a roll and biased thereon by a coil (not shown) spring in a well-known manner.

According to another embodiment, the coil spring is omitted.

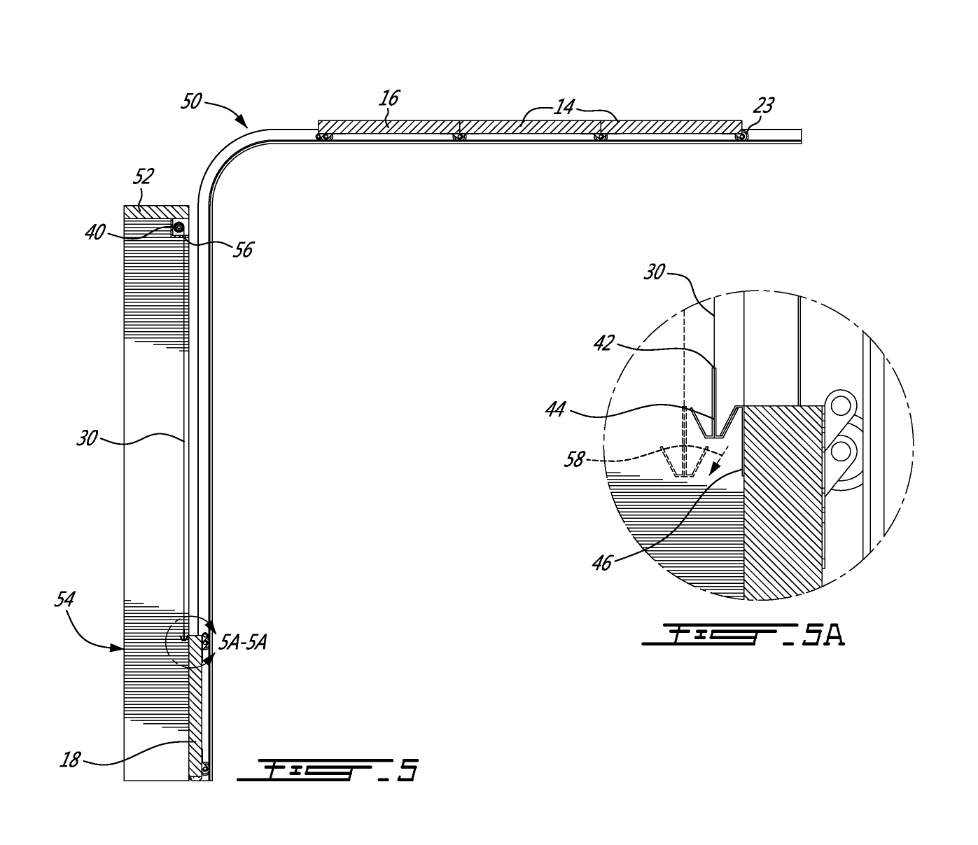

With reference to FIG. 5A, the distal edge 42 of the net 30 is provided with a first attachment, in the form of an elongated transversal hook 44, that cooperates with a second attachment on the last panel 18, in the form of an elongated transversal inverted V-shaped track 46. The second attachment 46 allows removably securing the edge of the distal edge 42 of the net 30 onto the last panel 18 along its width.

In operation, while the distal edge 42 of the net 30 is secured to the lowest panel 18, which is detached from the panel 16 and remains to the ground, raising the panels 14-16 causes the mosquito net 30 to be deployed in front of the opening.

The garage door assembly 10 can be equipped with a conventional automatic door opener (not shown) to automatically open the door with or without the lowest panel 18 detached and the net 30 attached thereto. The garage door assembly can also be opened manually.

The garage door assembly 10 allows selective aeration through the garage door opening while preventing small animals and insects from entering.

It is to be noted that the garage door assembly 10 can be provided with other conventional equipments such as a lock, sealing and security sensors (both not shown).

The screen 30 is not limited to the illustrated mosquito net and can be replaced by any sheet made of any material that is permeable to air. There are also no limitations in the size and configuration of the screen openings.

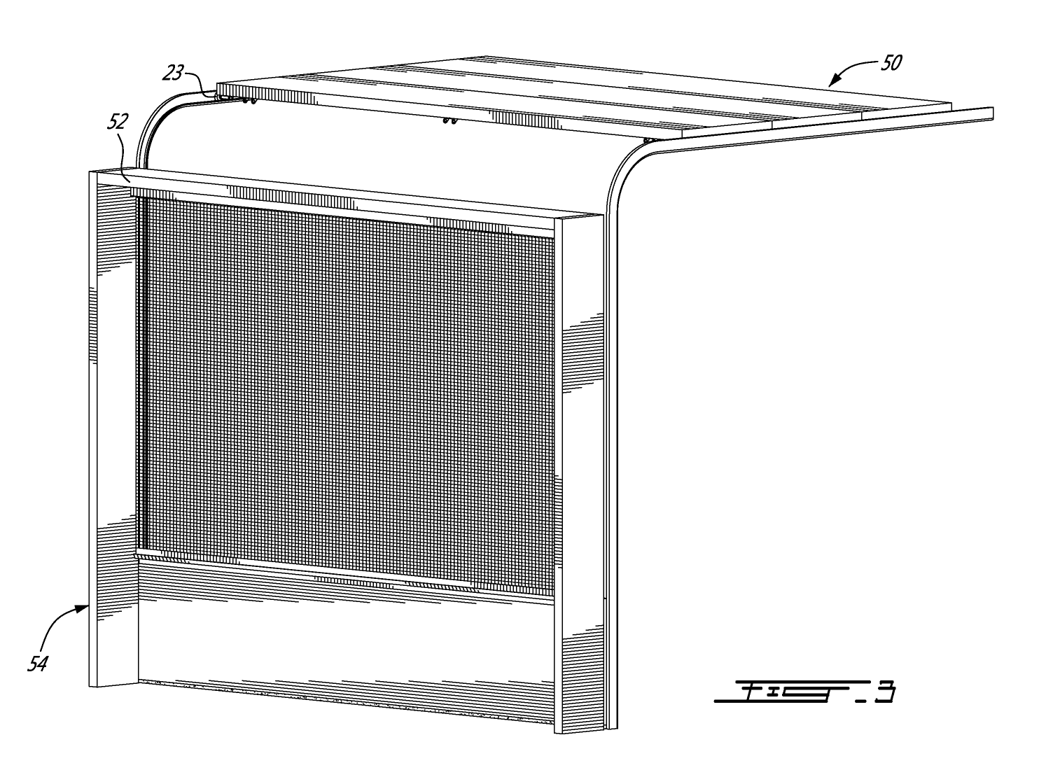

A garage door assembly 50 according to a second illustrative embodiment will now be described with reference to FIGS. 3-5A.

Since the assembly 50 is similar to the assembly 10, only the differences between these two assemblies will be described herein in more detail herein for concision purposes.

The container 40 is secured on a horizontal top panel 52 which is a part of the door frame 54 that is positioned outside the opening that is to be closed by the door assembly 10. A slit 56 is provided in the container 40 to allow passage for the net 30.

Contrarily to the case of the garage door assembly 10, the net/screen 30 cannot be automatically deployed by raising the door panels 14-16 since their movements are in opposite directions. The mosquito net 30 is deployed similarly to a conventional roller blind by pulling thereon. As can be better seen in FIG. 5A, the net 30 can be attached along the edge of the panel 18 by hanging the hook portion 44 onto the track 46 that is secured along the edge of the panel 18 as described hereinabove with reference to the assembly 10. Taking advantage of the coil spring and roll to which the net 30 is mounted, the net 30 can be retracted by pulling thereon after unhooking it from the track 46 (see arrow 58 in FIG. 5A).

The remaining operation of the door assembly 50 is similar to the operation of the door assembly 10 described hereinabove.

A person skilled in the art will now appreciate that a user may decide to open and close its garage door as any other garage door, without having to permanently remove the mosquito net, which remains ready to be deployed at all time.

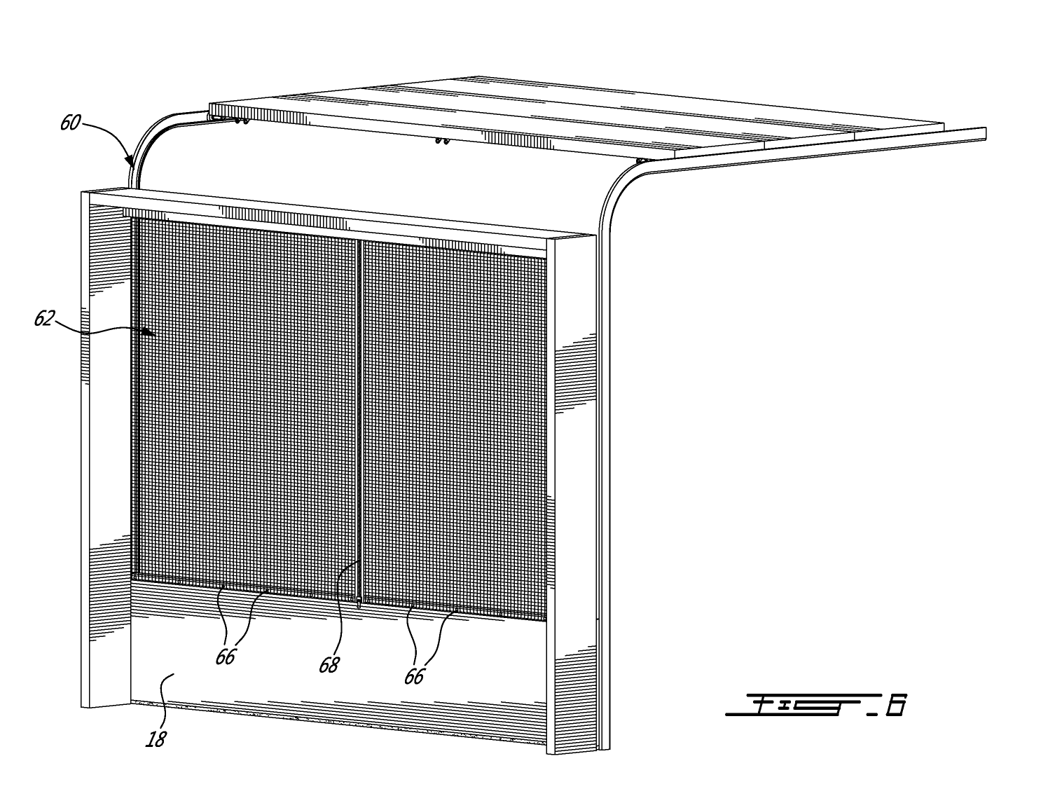

A garage door assembly 60 according to a third illustrative embodiment will now be described with reference to FIGS. 6.

Since the assembly 60 is similar to the assembly 50, only the differences between these two assemblies will be described herein in more detail herein for concision purposes.

The difference between both assemblies 60 and 50 lies within the configuration of the net 62. In the case of the assembly 60, the net 62 is attachable near the edge 64 of the lowest panel 18 therealong via snap buttons 66. Also, the net 62 includes an opening closed by a zipper 68 that allows easy passage to a person without having to completely or partially retract the net 62.

The position and orientation of the zipper 68 may of course be different than those illustrated.

Also, other attaching means than snap buttons can be provided to secure the edge or another portion of the mosquito net 62 to the panel 18.

Velcro™ or magnets (not shown) can be used instead of the snap buttons 66 and/or zipper 68.

According to another embodiment, a kit is provided to retrofit a conventional sectional overhead garage door assembly with a deployable screen as described hereinabove. Such a kit includes for example separable hinges 22, rollers 23 with brackets 38, a mosquito net 30 mounted on a roll as described hereinabove and/or received in a containers 40 for mounting on the garage door frame or one of its panel and complementary attachment for removably attaching the net 30 onto the last pane of the door.

It is to be noted that many modifications could be made to the garage door assembly described hereinabove and illustrated in the appended drawings. For example:
other arrangement and mechanism than the rollers and tracks can be provided to maintain in position the door panels and to allow movement thereof relative to the door opening;
the container that receives the net can be omitted. The net can be mounted on a roll as described hereinabove directly onto the door panel or door frame;
the screen is not limited to be mounted on a roll for deployment. According to another embodiment (not shown), the screen is folded or simply deposited in a container mounted to the next to last panel;
the number, size and material of the door panels may vary; and
the screen is not limited to cover the whole area of the opening. According to other embodiments (not shown), the screen is replaced by an opaque material including one or more sections made from a net.

It is to be understood that the garage door assembly is not limited in its application to the details of construction and parts illustrated in the accompanying drawings and described hereinabove. The garage door assembly is capable of other embodiments and of being practiced in various ways. It is also to be understood that the phraseology or terminology used herein is for the purpose of description and not limitation. Hence, although the garage door assembly has been described hereinabove by way of illustrative embodiments thereof, it can be modified, without departing from the spirit, scope and nature of the subject invention.

What is claimed is:

1. A garage door assembly for closing an opening that is at least partially circumscribed by a frame, the garage door assembly comprising:
a series of abutting panels assembled in such a way that two adjacent panels are interconnected to allow pivotal movement therebetween; the panels being slidably mounted in two lateral parallel tracks therebetween for reciprocal movement in unison therealong, between a lowered position, wherein the opening is closed, and a raised position, wherein the opening is clear; the series of abutting panels including a last and a next to last panels that are detachable; the last panel having at least one first attachment;
a screen mounted to one of i) the frame and ii) the next to last panel so as to be deployable in front of the opening when the last panel is detached and the other panels are in the raised position;
the screen having at least one second attachment for cooperating with the at least one first attachment for removably attaching the deployable screen to the last panel.

2. A garage door assembly as recited in claim 1, wherein the last and next to last panels are detachably assembled via two-parts separable hinches.

3. A garage door assembly as recited in claim 1, wherein the separable hinges includes a first portion secured to the last panel, a second portion secured to the next to last panel, and a removable pivot pin that removably holds together the first and second portions.

4. A garage door assembly as recited in claim 1, wherein each panel is slidably mounted in the parallel tracks via rollers.

5. A garage door assembly as recited in claim 4, wherein the last and next to last panels include additional rollers for their maintains in the two lateral parallel tracks therebetween when the last panel is detached.

6. A garage door assembly as recited in claim 1, wherein the screen is mounted to one of i) the frame and ii) the next to last panel so as to be retractable.

7. A garage door assembly as recited in claim 6, wherein the screen is mounted on a roll.

8. A garage door assembly as recited in claim 6, wherein the screen is mounted to the next to last panel.

9. A garage door assembly as recited in claim 1, wherein the screen is mounted in a container which is secured to one of i) the frame and ii) the next to last panel.

10. A garage door assembly as recited in claim 1, wherein the at least one first attachment includes a hook and the at least one second attachment includes a V-shaped track for receiving the hook.

11. A garage door assembly as recited in claim 10, wherein the hook is elongated and extends along the width of the screen.

12. A garage door assembly as recited in claim 1, wherein the at least one first and second attachments includes snap buttons.

13. A garage door assembly as recited in claim 1, wherein the screen includes a closable opening.

14. A garage door assembly as recited in claim 1, wherein the screen is a mosquito net.

15. A garage door assembly as recited in claim 1, wherein the screen includes a mosquito net portion.

16. A kit for retrofitting a sectional overhead garage door assembly with a selectively deployable screen; the garage door assembly including a series of abutting panels assembled in such a way that two adjacent panels are interconnected to allow pivotal movement therebetween; the panels being slidably mounted in two lateral parallel tracks therebetween for reciprocal movement in unison therealong, between a lowered position, wherein the opening is closed, and a raised position, wherein the opening is clear; the kit comprising:
separable hinges, each having a first part mountable to the last panel and a second part mountable to the next to last panel of the series of abutting panels and a removable pivot pin that holds together the first and second parts;
at least one first attachment for mounting to the last panel; and
a screen for mounting to the next to last panel or to a frame of the garage door assembly to be deployable in front of the opening when the last panel is detached from the next to last panel and the other panels are in the raised position; the screen having at least one second attachment for cooperating with the at least one first attachment for removably attaching the deployable screen to the last panel.
